(19) United States
(12) Patent Application Publication
(10) Pub. No.: US 2005/0104506 A1
(43) Pub. Date: May 19, 2005

(54) Triode Field Emission Cold Cathode Devices with Random Distribution and Method

(76) Inventors: Meng-Jey YOUH, Taoyuan County (TW); Chun-Lung TSENG, Kaohsiung County (TW); Yao-Hsien Joseph HUANG, Arcadia, CA (US); Michelle LIN, Arcadia, CA (US)

Correspondence Address: SHELDON & MAK, INC, 225 SOUTH LAKE AVENUE, 9TH FLOOR, PASADENA, CA, 91101, US

(21) Appl. No.: 10/707,058

(22) Filed: Nov. 18, 2003

(51) Int. Cl. H01J 1/62

(52) U.S. Cl. 313/496; 445/50

(57) ABSTRACT

A method of manufacturing a triode field emission cold cathode device having randomly distributed field emission emitters comprising the steps of providing a substrate (10), depositing a first conductive layer (11) on the substrate, spraying the preceding layer with a random pattern of masking material (20), depositing an insulating layer (13) on the masked preceding layer, depositing a second conductive layer (14) on the insulting layer, and removing the masking material. A triode field emission cold cathode device having randomly distributed field emission emitters is also provided.

### BACKGROUND OF INVENTION

Field emission devices are the promising approach for display, lamp and LCD backlight. Cold cathode field emission devices have several advantages over other types of light emission devices, including low power dissipation and high intensity. Therefore, to improve field emitter and reduce the complexity of fabricating is an important issue.

Several types of electron emitter structures are well known, i.e., thermionic emission, diode cold cathode emission, triode cold cathode emitter, etc. Triode electron emitters are considered to be more efficient for field emission devices. Typical triode electron emitter structures are disclosed in U.S. Pat. No. 3,789,471. Prior triode field emission cold cathode devices generally require a very sharp metal or silicone tip to cause electrons to be drawn off, or emitted. An extraction electrode is formed to completely surround the tip to provide the extraction potential. The electrons are extracted by applying voltage to the gate layer. While electrons are extracted from the emitters, the fixed electric field applied to the anode causes the electrons to be accelerated toward the anode plate. This structure can reduce the required voltage applied to the gate layer, due to the short distance between the gate layer and the emitter. A major problem with these devices is the difficulty in fabricating. It also hard to achieved large panel size.

What is missing from the prior art is a low cost and simple process for making a flat cold cathode device.

### SUMMARY OF INVENTION

The present invention meets this need by provide a method of manufacturing a triode field emission cold cathode device having randomly distributed field emission emitters comprising the steps of providing a substrate (10), depositing a first conductive layer (11) on the substrate, spraying the preceding layer with a random pattern of masking material (20), depositing an insulating layer (13) on the masked preceding layer, depositing a second conductive layer (14) on the insulting layer; and removing the masking material.

Optionally and preferably, emitter material (16) can be deposited after the removing step. The depositing step for the emitter material can include printing, spin-coating, or direct growth. Preferably, the emitter material has a low work function, and comprises diamond, carbon nanotubes, LaB6, Si, or Mo.

Preferably, the masking material can be dissolved in water or solvents. The masking material may either be a form of solid particles, liquid droplets, or a combination of solid particles and liquid droplets. The masking material can be photosensitive material, plastic, glass, metal or ceramic particles. The spraying step may comprise dusting, sprinkling, or smoking.

In a further embodiment, a catalyst layer (12) is deposited on the first conductive layer (11), prior to the spraying step, for growing emitter material (16). Preferably, the catalyst layer is Ni, Cu, Ag, Co, Fe, or diamond-seeded film.

In a still further embodiment, the first conductive layer comprises conductive material prepared by a sol-gel method. Optionally, the conductive material prepared by a sol-gel method is metal-containing compound.

In a still further embodiment, the first conductive layer comprises a hardening material, and a step of hardening the layer is added. Optionally, the hardening material is a mixture of conductive powders and polymers. Additionally, optionally the hardening material can be prepared by a sol-gel method. Additionally, optionally the hardening step comprises either radiation curing or sol-gel processing.

In a still further embodiment, the steps of depositing a photosensitive layer, exposing the photosensitive layer, and developing the photosensitive layer are added.

An addressable field emission array, wherein each addressable pixel comprises randomly distributed field emission emitters, manufactured using the methods of the invention, is described.

A field emission array having pixels with randomly distributed field emission emitters is described, comprising a substrate (10), a first conductive layer (11) in contact with the substrate, emitter material in contact with the preceding layer, an insulating layer (13) in contact with the preceding layer having openings randomly disposed through the insulating layer and in registration with the emitter material, and a second conductive layer (14) in contact with the insulating layer and having openings disposed through the second conductive layer in registration with the openings in the insulating layer, wherein the emitter material is exposed through the openings in the insulating layer and the openings in the second conductive layer. In a further embodiment, a catalyst layer is in contact with the first conductive layer. In a still further embodiment, the emitter material is sintered into the preceding layer.

### BRIEF DESCRIPTION OF DRAWINGS

For a more complete understanding of the present invention, the following descriptions are taken in conjunction with the accompanying drawings, in which:

FIG. 1 depicts the process of manufacturing a triode field emission cold cathode emitter according to one embodiment of the invention.

FIG. 2 depicts the process of FIG. 1, adding a catalyst layer.

FIG. 3 depicts the process of FIG. 1, according to a further embodiment.

FIG. 4 depicts the process of FIG. 4, according to a further embodiment.

FIG. 5 is a schematic representation of an addressable field emission emitter array with randomly distributed field emission emitters.

### DETAILED DESCRIPTION

The invention has particular application to fabrication of flat triode cold cathode electron emitters. In this invention, random triode emitters can be achieved without any photolithography process. It will reduce manufacturing cost and easily achieve large panel size.

Normally, a large area cold cathode field emission device consists of hundreds or thousands of gate controlled triode emitters. When an extracting voltage is applied to the gate metal, an electron can be extracted from the emitter material and directed toward the anode plate. The anode plate can be a transparent conductive layer coated with electron-excited phosphor. In this case, the regular arranged emitter structure is not necessary for large area.

In one embodiment, the vertical gate structure can be prepared by randomly distributing mask material onto the conductive-coated substrate. Subsequently, an insulating layer and a gate conducting layer are deposited onto the conductive-coated substrate. After remove the mask material, emitter material can be either grown or deposited in the center of the masked area. One advantage of this process is to eliminate the steps of photolithography. Another advantage is that high emitter density can be easily achieved by increasing the density of the mask material.

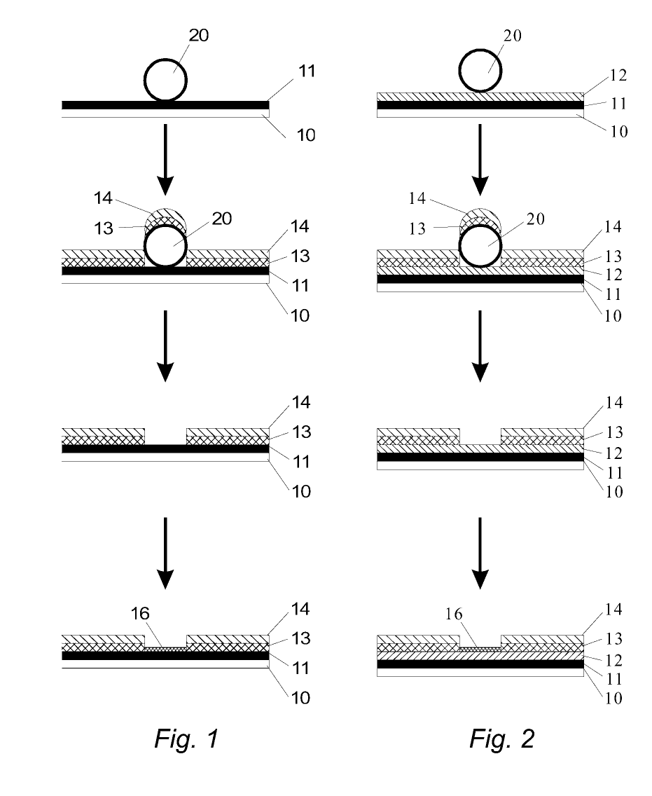

FIG. 1 shows the process flow of a first embodiment of the present invention. A first conductive layer 11 for the cathode, which can be Ni, Cu, Ag, Co, Fe, or one of the other conductive metals, is deposited on a substrate 10. Subsequently, a masking material 20 is randomly sprayed onto the first conductive layer 11. The spraying may be done by such methods as dusting, sprinkling, or smoking. The masking material can be photosensitive material, plastic, glass, metal or ceramic particles which can be removed in a later step. The masking material can be in a form of solid particles or liquid droplets, or a combination.

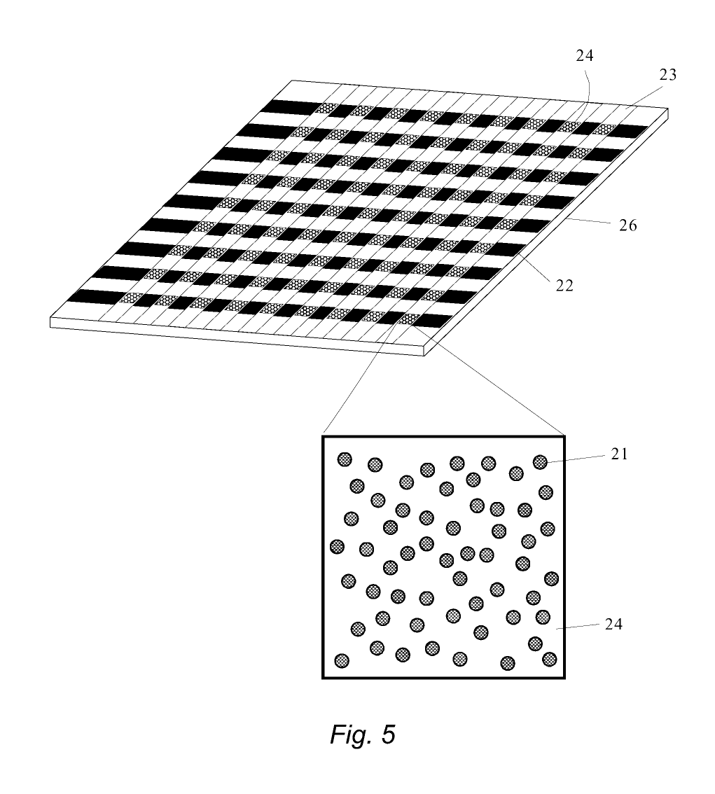

After the masking material spraying process, an insulating layer 13 and a second conductive layer 14 for the gate are deposited to form the triode field emission emitters. The masking material 20 is then removed, such as by water, solvents, or developers in an ultrasonic bath or other process known in the art, leaving openings in the insulating layer 13 and second conductive layer 14. The resulting triode field emission emitters 21 are then randomly distributed, as shown on FIG. 5. Subsequently, an emitter material 16 can be deposited in the openings, in electrical contact with conductive layer 11. The deposition process can be printing (such as inkjet printing or screen-printing), spin-coating, or direct growth, depending on the material of the conducting layer 11. Preferably, a low work function emitter material 16, i.e., carbon nanotubes or nano-diamond particles can be used. LaB6, Si, or Mo can also be used.

FIG. 2 shows the process flow of a second embodiment of the present invention. As in the first embodiment, first conductive layer 11 for the cathode is deposited on substrate 10. A catalyst layer 12, which can be Ni, Cu, Ag, Co, Fe, or diamond-seeded film for the growth of emitter material 16, is then deposited on the first conductive layer 11. Subsequently, masking material 20 is randomly sprayed onto the catalyst layer 12. After the masking material spraying process, an insulating layer 13 and a second conductive layer 14 for the gate are deposited to form the triode field emission emitters 21. The masking material is then removed, such as by water, solvents, or developers in an ultrasonic bath or other process known in the art, leaving openings in the insulating layer 13 and second conductive layer 14. Subsequently, emitter material 16 can be selectively grown in openings to catalyst layer 12.

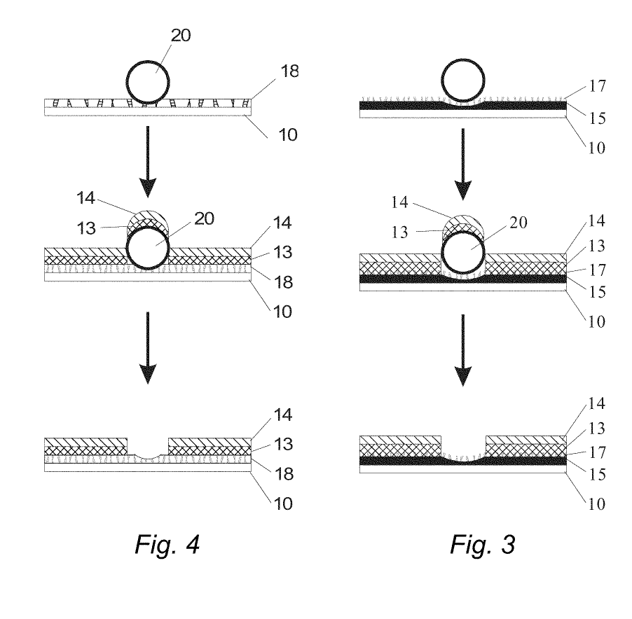

FIG. 3 shows the process flow of a third embodiment of the present invention. In this case, the first conductive layer 11 is replaced with a hardening conductive layer 15, which is in a form of liquid before treatment and becomes solid after treatment. This hardening conductive layer 15 may be conductive paste, or other conductive material prepared by sol-gel method. The hardening treatment may include radiation curing or sol-gel processing. Subsequently, emitter material 17 is sprayed onto the preceding layer by the method of dusting or sprinkling. After the hardening treatment for the hardening conductive layer 15, emitter material 17 is fixed onto the conductive layer. Masking material 20 is then randomly sprayed onto the previous layer. Typically, gravitational force results in some depression of the layer, as show in FIG. 3, although this is not required. After the deposition of an insulating layer 13 and a second conductive layer 14 for the gate of the emission structure, the masking material is removed by water, solvents or developers. The steps of depositing and removing the masking material are the same with the description in the first and second embodiments.

FIG. 4 shows the process flow of a fourth embodiment of the present invention. In this case, the first conductive layer 11 is replaced with sintered hardening conductive layer 18. As in the third embodiment, this layer is in a form of liquid before treatment and becomes solid after treatment. Sintered hardening conductive layer 18 may be conductive paste, or other conductive material prepared by sol-gel method, which is mixed with emitters. Before hardening the sintered hardening conductive paste layer 18, mask material 20 is sprayed onto the layer. The bombardment force induced by spraying the masking material may further expose the emitters. As in previous embodiments, after the deposition of insulating layer 13 and second conductive layer 14 for the gate of the emission structure, masking material 20 is removed.

Field Emission Display Array

Further, an addressable field emission display array also can be produced by the randomly distributed mask methods. The size range of a display pixel is normally from 0.2 mm to 0.5 mm which depends on the size and resolution of panel. In each pixel, the emission area can comprise several tens or hundreds of emitters. It is not necessary to have a regular arranged emitters in each pixel. The triode gate structure can be produced in each pixel by one or more of the processes mentioned above, or by a combination or equivalent, and have random distribution. Therefore, the present invention is a suitable method to produce an addressable array for field emission display.

The embodiments described above may be used in the fabrication of addressable field emission emitter arrays. Using the present invention, it is possible to construct a flat field emission display with random triode cold cathode structure. With reference to FIG. 5, for every pixel 24 of the field emission emitter array 26, the triode field emission emitters 21 are randomly distributed in each pixel using one or more of the processes described, or by a combination or equivalent. In each pixel, the emission area can comprise several tens or hundreds of emitters. The size of each conductive base 22 or gate strip 23 in FIG. 5 is in the range of 0.2 to 0.5 mm, indicating that the distribution of the field emission emitters is not necessary to be precisely defined. The process of Printed Circuit Board (PCB) can be used to replace photolithography processes.

Although the present invention has been discussed in considerable detail with reference to certain preferred embodiments, other embodiments are possible. For example, further steps of depositing a photosensitive layer, exposing the photosensitive layer, and developing the photosensitive layer could be added. Therefore, the scope of the appended claims should not be limited to the description of preferred embodiments contained in this disclosure.

All features disclosed in the specification, including the claims, abstract, and drawings, and all the steps in any method or process disclosed or claimed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Also, any element in a claim that does not explicitly state “means for” performing a specified function or “step for” performing a specified function, should not be interpreted as a “means” or “step” clause as specified in 35 U.S.C. § 112.

1. A method of manufacturing a triode field emission cold cathode device having randomly distributed field emission emitters comprising the steps of:
providing a substrate (10);
depositing a first conductive layer (11) on the substrate;
spraying the preceding layer with a random pattern of masking material (20);
depositing an insulating layer (13) on the masked preceding layer;
depositing a second conductive layer (14) on the insulting layer; and
removing the masking material.

2. The method of claim 1, further comprising the step of depositing an emitter material (16) after the removing step.

3. The method of claim 2, wherein the depositing step comprises printing, spin coating, or direct growth.

4. The method of claim 2, where the emitter material comprises diamond, carbon nanotubes, LaB6, Si, or Mo.

5. The method of claim 1, where the masking material can be dissolved in water or solvents.

6. The method of claim 1, wherein the masking material is either a form of solid particles, liquid droplets, or a combination of solid particles and liquid droplets.

7. The method of claim 1, wherein the masking material is photosensitive material, plastic, glass, metal or ceramic particles.

8. The method of claim 1, wherein the spraying step comprises dusting, sprinkling, or smoking.

9. The method of claim 1, further comprising the step of depositing a catalyst layer (12) on the first conductive layer (11), prior to the spraying step, for growing an emitter material (16).

10. The method of claim 9, wherein the catalyst layer is Ni, Cu, Ag, Co, Fe, or diamond-seeded film.

11. The method of claim 1, where the first conductive layer comprises a hardening material and further comprising the step of hardening the first conductive layer.

12. The method of claim 11, where the hardening material is a metal-containing compound.

13. The method of claim 11, where the hardening material is prepared by a sol-gel method.

14. The method of claim 11, where the hardening material is a mixture of conductive powders and polymers.

15. The method of claim 11, where the hardening step comprises either radiation curing or sol-gel processing.

16. The method of claim 1, further comprising the steps of depositing a photosensitive layer, exposing the photosensitive layer, and developing the photosensitive layer.

17. A method of manufacturing a triode field emission cold cathode device having randomly distributed field emission emitters comprising steps for:
randomly masking conductive material; and
removing the masking material.

18. A method of manufacturing a triode field emission cold cathode device having randomly distributed field emission emitters comprising the steps of:
spraying a conductive layer with a random pattern of masking material; and
removing the masking material.

19. An addressable field emission array, wherein each addressable pixel comprises randomly distributed field emission emitters.

20. The addressable field emission array of claim 19, wherein the randomly distributed field emission emitters are manufactured using a random pattern of masking material.

21. A field emission array having pixels with randomly distributed field emission emitters, comprising:
a substrate (10);
a first conductive layer (11) in contact with the substrate;
emitter material in contact with the preceding layer;
an insulating layer (13) in contact with the preceding layer having openings randomly disposed through the insulating layer and in registration with the emitter material; and
a second conductive layer (14) in contact with the insulating layer and having openings disposed through the second conductive layer in registration with the openings in the insulating layer;
wherein the emitter material is exposed through the openings in the insulating layer and the openings in the second conductive layer.

22. The field emission array of claim 21, further comprising a catalyst layer in contact with the first conductive layer.

23. The field emission array of claim 21, where the emitter material is sintered into the preceding layer.
